(19) United States
(12) Patent Application Publication
(10) Pub. No.: US 2007/0254201 A1
(43) Pub. Date: Nov. 1, 2007

(54) ANODE FLOW FIELD BOARD FOR FUEL CELL

(76) Inventors: Hsi-Ming Shu, Taipei (TW); Tsang-Ming Chang, Taipei (TW); Chih-Jung Kao, Taipei (TW); Chun-Wei Pan, Taipei (TW); Wei-Li Huang, Taipei (TW)

Correspondence Address: G. LINK CO., LTD., 3550 BELL ROAD, MINOOKA, IL, 60447, US

(21) Appl. No.: 11/739,690

(22) Filed: Apr. 24, 2007

(30) Foreign Application Priority Data
Apr. 27, 2006 (TW) 095207173

(51) Int. Cl. H01M 8/02

(52) U.S. Cl. 429/38; 429/39

(57) ABSTRACT

The present invention is an anode flow field board for fuel cell, which comprises a substrate, and a shunt portion configured on the substrate, an inlet channel structure, at least one slot body, an outlet channel structure, and an outlet hole; wherein, the shunt portion is formed by digging a small area of the substrate as a hollow area; the inlet channel structure is connected between the shunt portion and these slot bodies, and the configured positions for the arrangement of these slot bodies are associated with these configured positions of anodes for each membrane electrode assembly; the outlet channel structure is connected between these slot bodies and the outlet hole; and, the outlet hole is connected to the outlet channel structure, and the outlet hole is formed by digging a small area of the substrate as a hollow area.

### FIELD OF THE INVENTION

The present invention relates to a flow field board for fuel cell, and particularly to an anode flow field board, which has an extremely light overall weight, and low manufacturing cost, and with a mixing process causing uniform density to provide the anode fuel and anode product with a fluid field environment for smoothly flowing.

### BACKGROUND OF THE INVENTION

The fuel cell is a generation device for directly transforming the chemical energy stored in fuel into electrical energy through the electrode reaction. There are numerous types of fuel cell, and with different categorization methods. If the fuel cells are categorized by the difference of electrolyte characteristics, there are five types of fuel cells with different electrolytes, such as alkaline fuel cell, phosphorous acid fuel cell, proton exchange membrane fuel cell, molten carbonate fuel cell, solid oxide fuel cell.

In the conventional fuel cell structure, the flow field board is placed at both sides of the membrane electrode assemblies, and the used material should be provided with the features of high conductivity, high strength, easy to manufacture, light weight, and low cost. Currently, the material for making flow field board is graphite, aluminum, and stainless steel, and normally is made of graphite; and, machining channels on the flow field board as the channels for supplying fuel, so the reactant could reach the expansion layer through the channel, and enter the catalyst layer for joining the reaction. Moreover, the flow field board could have the function for conducting electric current, so the current generated from the reaction could be conducted and applied, and have the function as current collector board.

However, the conventional flow field board, such as graphite board, has a large volume, and the weight is not light enough. Therefore, the inventor of the present invention has been in view of the disadvantages of the conventional flow field board, and worked hard for improvement to invent an anode flow field board.

### SUMMARY OF THE INVENTION

The main object of the present invention is to provide an anode flow field board, which has an extremely light overall weight, and low manufacturing cost, and to provide the anode fuel and anode product with a fluid field environment for smoothly flowing.

The another object of the present invention is to provide an anode flow field board with current collector function, which could not only greatly reduce the volume and weight of the fuel cell itself, but also improve the current collector function of the flow field board.

The further another object of the present invention is to provide an anode flow field board with uniform density and uniform flow volume after fuel mixing, which could increase the power generation performance of the cell.

To this end, the present invention provides an anode flow field board for fuel cell, which comprises a substrate, and a shunt portion configured on the substrate, an inlet channel structure, at least one slot body, an outlet channel structure, and an outlet hole; wherein, the shunt portion is formed by digging a small area of the substrate as a hollow area; the inlet channel structure is connected between the shunt portion and these slot bodies, and the configured positions for the arrangement of these slot bodies are associated with these configured positions of anodes for each membrane electrode assembly; the outlet channel structure is connected between these slot bodies and the outlet hole; and, the outlet hole is connected to the outlet channel structure, and the outlet hole is formed by digging a small area of the substrate as a hollow area.

### BRIEF DESCRIPTION OF THE DRAWINGS

The above objective and advantages of the present invention will become more apparent with reference to the appended drawings wherein:

FIG. 1 is an elevation view for an anode flow field board for fuel cell of a preferred embodiment according to the present invention;

FIG. 2 is an elevation view for a current collector sheet of a preferred embodiment according to the present invention;

FIG. 3 is an elevation view for an anode flow field board with current collector sheets of a preferred embodiment according to the present invention;

FIG. 4 is an elevation view for an anode flow field board configured with electric components of a preferred embodiment according to the present invention;

FIG. 5 is an elevation view for an anode flow field board configured with electric components of another preferred embodiment according to the present invention;

FIG. 6 is a diagram for an anode flow field board for fuel cell of another varied embodiment according to the present invention; and

FIG. 7 is a diagram for an anode flow field board for fuel cell of further another varied embodiment according to the present invention.

### DETAILED DESCRIPTION OF THE INVENTION

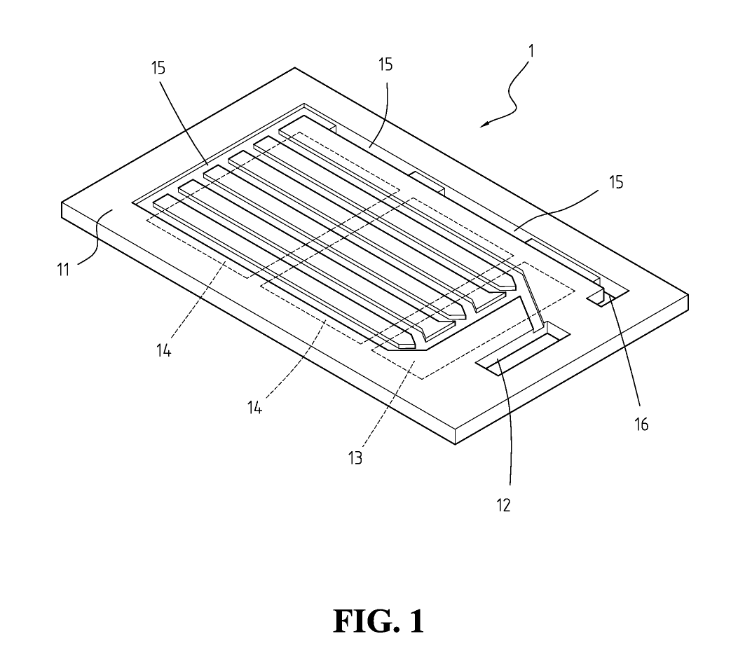

As shown in FIG. 1, the anode flow field board 1 according to the present invention is applied to the fuel cell, in which the fuel cell is provided with at least one membrane electrode assembly. The anode flow field board 1 according to the present invention comprises: a substrate 11, a shunt portion 12, an inlet channel structure 13, at least one slot body 14, an outlet channel structure 15, and an outlet hole 16, and these components will be detailed described in the followings.

The substrate 11 could be selected with one from anti-chemical non-conductive engineering plastic substrate, graphite substrate, metal substrate, plastic carbon substrate, FR4 substrate, FR5 substrate, epoxy resin substrate, glass-fiber substrate, ceramic substrate, polymer plasticized substrate, and composite material substrate. If the shunt portion 12, the inlet channel structure 13, at least one slot body 14, the outlet channel structure 15, and the outlet hole 16 are configured on the upper surface of the substrate 1, they will form a single-face anode flow field board 1. On the other hand, if the shunt portion 12, the inlet channel structure 13, at least one slot body 14, the outlet channel structure 15, and the outlet hole 16 are configured both on the upper surface and the lower surface of the substrate 1, they will form a dual-face anode flow field board 1.

The shunt portion 12 is configured at one side of the substrate 11, and a small area of the substrate 11 is dug as a hollow area to form a shunt portion 12. The hollow area of the shunt portion 12 could accommodate the flow-in anode fuel, such as methanol solution. When the flow-in anode fuel is filled up the shunt portion 12, the anode fuel will flow toward the inlet channel structure 13.

The inlet channel structure 13 is configured on the substrate 11, and connected between the shunt portion 12 and at least one slot body 14. The means for realizing the inlet channel structure 13 is dug from the surface of the substrate 11 with a plurality of slots, and these ends of the plurality of slots in the same direction are connected to the shunt portion 12. At the same time, these ends of the plurality of slots in another direction are connected with the slot bodies 14. The inlet channel structure 13 employs a design of uniform flow volume, so the anode fuel from the shunt portion 12 after flowing through the plurality of slots, would have the flow-out volume of the anode fuel flowing out from each end connected to the slot body 14 to form as an uniform flow volume.

At least one slot body 14 are arranged and configured on the substrate 11, and each configured position of each slot body 14 is correspondingly associated with the configured position of the anode for each membrane electrode assembly. The means for realizing these slot bodies 14 are dug from the surface of the substrate 11 to form a plurality of parallel slots. The anode fuel from the inlet channel structure 13 will flow into each slot body 14; then, flowing to the anode of each membrane electrode assembly; furthermore, the anode product generated by the electrochemical reaction for the anode of each membrane electrode assembly will flow into each slot body 14; finally, the anode product and the residual anode fuel will flow to the outlet channel structure 15.

On the other hand, the slot body 14 could employ other structures, for example, employing a plurality of crossed slots to form a grid structure, and the plurality of grid-like slot bodies 14 are arranged and configured on the substrate 11. Moreover, the slot body 14 employs a groove structure, and is dug from the surface of the substrate 11 to form a recessed area.

The outlet channel structure 15 is configured on the substrate 11, and connected between these slot bodies 14 and the outlet hole 16. The design of a portion of outlet channel structure 15 closely adjacent to the slot bodies 14 employs the slot structure. The means for the slot structure is dug from the surface of the substrate 11 to form one or more than one grooves. The design of a portion of outlet channel structure 15 closely adjacent to the outlet hole 16 employs a strip-hole structure. The means for the strip-hole structure is dug from the surface of the substrate 11 to form one or more than one hollow strip-like area.

The design concept for a portion of the outlet channel structure 15 employing strip-hole structure is to enlarge the outlet channel to reduce the internal pressure of the anode flow field board 1. Thus, the design could smoothly discharge the anode product, such as CO₂, or bubbles to the outlet hole 16 from remaining in the outlet channel structure 15.

The outlet hole 16 is configured at one side of the substrate 11, and connected to the outlet channel structure 15. The means for realizing the outlet hole 16 is to dig a small portion of the substrate 11 as a hollow area. The configured position of the outlet hole 16 could be selected to be at the same side with the shunt portion 12 of the substrate 11. The anode product and the residual anode fuel from the outlet channel structure 15 could flow out to the anode flow field board 1 from the outlet hole 16.

Moreover, the surface of the substrate 11 could be further configured with circuitry, such as employing printed circuitry, and coating with a layer of protection painting on the surface of the printed circuitry, such as green paint. The printed circuitry is electrically connected to these current collector sheets 17.

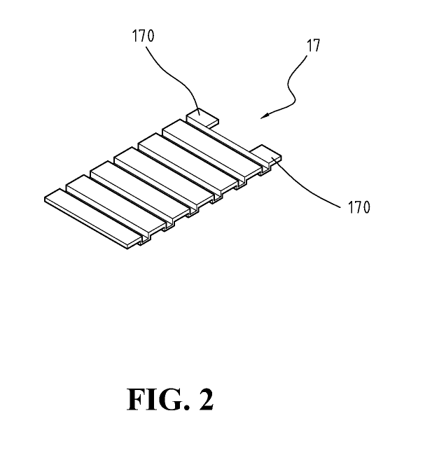

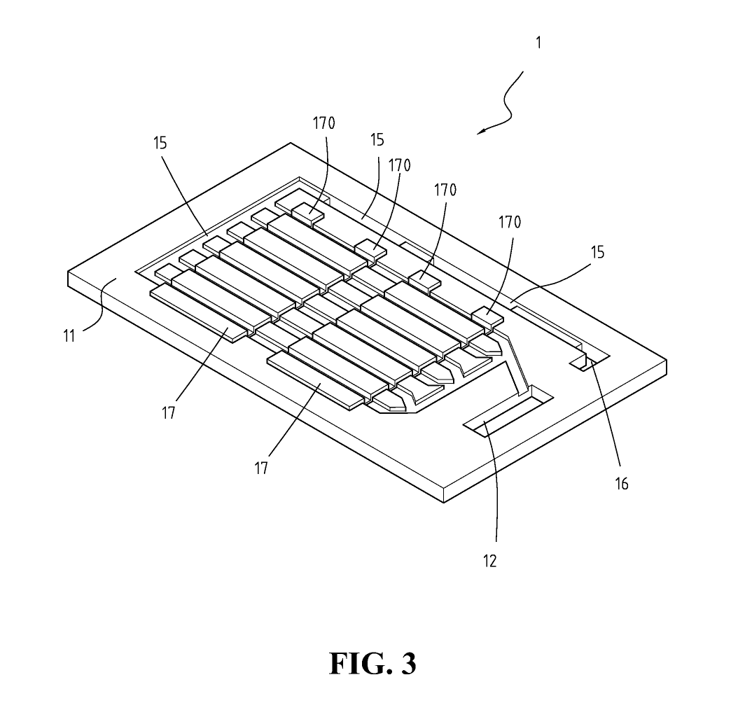

Furthermore, the present invention further comprises at least one current collector sheet 17. Please refer to FIG. 2 an elevation view for a current collector sheet 17 of a preferred embodiment according to the present invention, and FIG. 3 an elevation view for an anode flow field board with current collector sheets of a preferred embodiment according to the present invention. The material for current collector sheet 17 is a conductive material, and as an anti-chemical material for anti-erosion and/or anti-acid, for example selecting one from stainless steel (SUS316) sheet, gold foil, titanium metal, graphite material, carbon metal compound material, metal alloy sheet, and polymer conductive sheet with low resistance.

Each current collector sheet 17 is attached and fixed to each slot body 14. The current collector sheet 17 is provided with at least one flange 170, and these flanges 170 are protruded from the slot bodies 14. The concrete structure employed by the current collector sheet 17 is determined by the concrete structure of the slot body 14.

Moreover, a conductive sheet is further attached and sandwiched between each current collector sheet 17 and each slot body 14 (not shown). The conductive sheet could employ the high conductivity material, and could be chosen to use the spot-welding method, so as to bond these conductive sheet layers between these current collector sheets 17 and these slot bodies 14; or, with thermal press machine, employing a resin Prepreg or a bond with anti-erosion and/or anti-acid function, such as AB glue, to press and bond these conductive sheets between these current collector sheets 17 and these slot bodies 14. Furthermore, it could choose to select the sputtering and spraying process to form a layer of thin metal layer on the bottom surface of the current collector sheet 17; or, forming a layer of thin metal layer on the upper surface of the slot body 14. The material for the conductive sheet and thin metal layer could be selected from one of gold, copper, silver, carbon, high conductivity metal.

The conductive sheet is provided with at least one flange, and these flanges are protruded from the slot bodies 14.

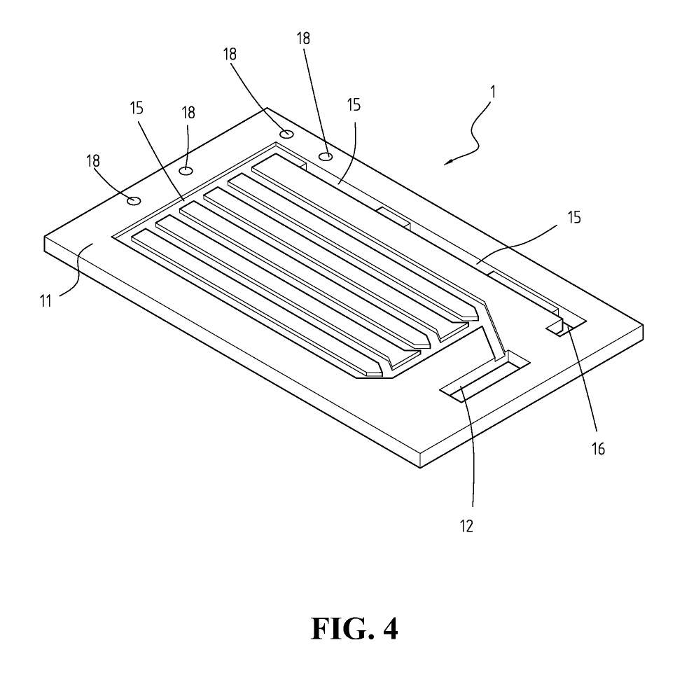

FIG. 4 is an elevation view for an anode flow field board configured with electric components of a preferred embodiment according to the present invention. The surface of the substrate 11 other than the area used by shunt portion 12, inlet channel structure 13, at least one slot body 14, outlet channel structure 15, and outlet hole 16 could be used to configure with at least one electric component 18. The embodiments of these electric components 18 are, for example, temperature sensor, density sensor, liquid level sensor, heating device, cooling device, and heating filaments.

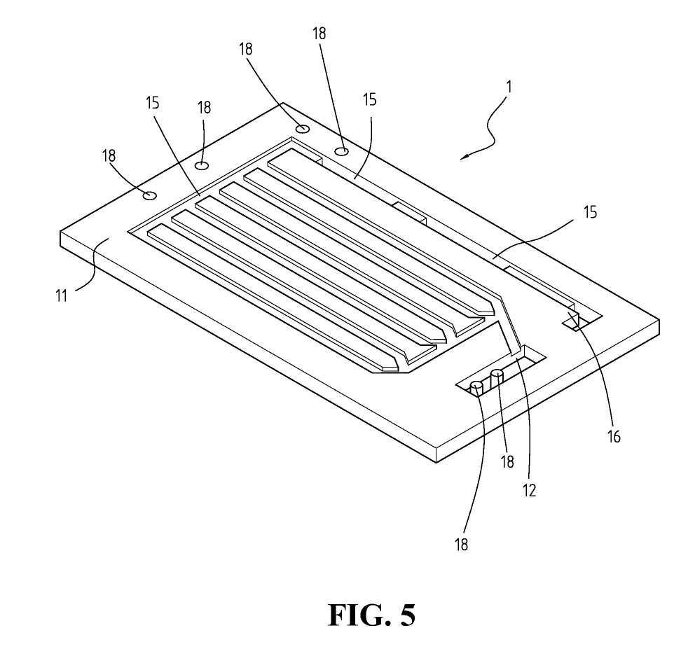

FIG. 5 is an elevation view for an anode flow field board configured with electric components of another preferred embodiment according to the present invention. The inner space formed by the hollow area of the shunt portion 12 could be used to accommodate at least one electric component 18. The embodiments of these electric components 18 are, for example, temperature sensor, density sensor, liquid level sensor, heating device, cooling device, and heating filaments.

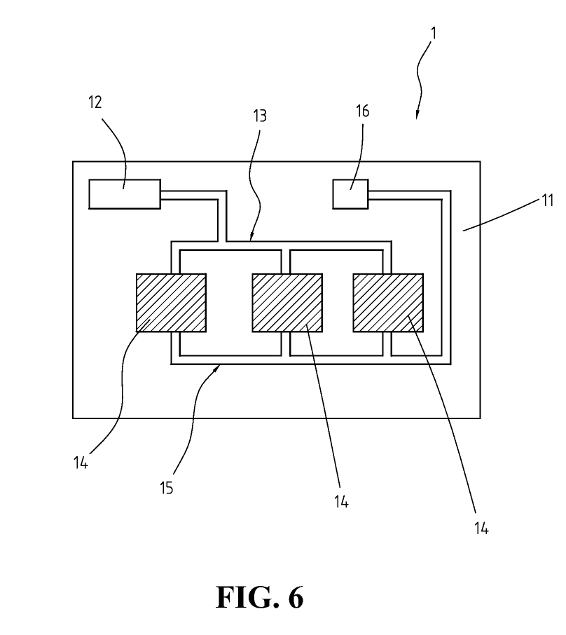

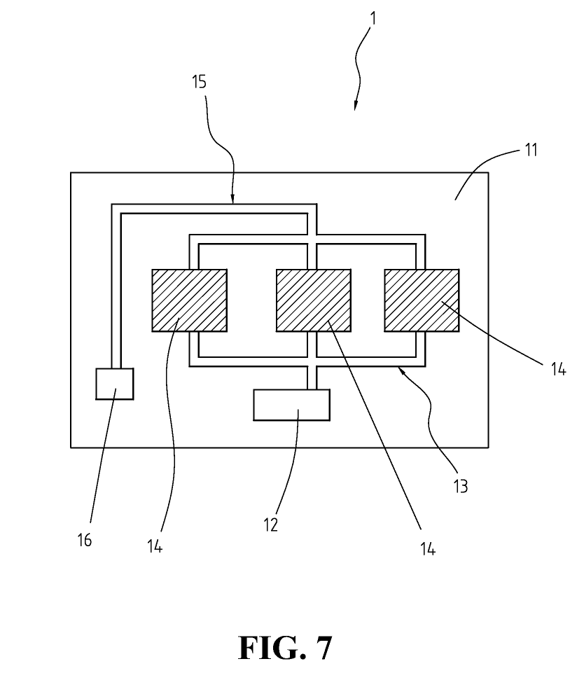

FIG. 6 is a diagram for an anode flow field board for fuel cell of another varied embodiment according to the present invention, and FIG. 7 is a diagram for an anode flow field board for fuel cell of further another varied embodiment according to the present invention. FIG. 6 and FIG. 7 are the varied configuration examples for the members configured on the substrate 11, such as shunt portion 12, inlet channel structure 13, these slot bodies 14, outlet channel structure 15, and outlet hole 16. The skilled in the art could modify to other different configurations, and these variations are still within the scope of the present invention.

The anode flow field board 1 according to the present invention could be applied to various fuel cells, such as fuel cell using methanol fuel, fuel cell using liquid fuel, fuel cell using gas fuel, and fuel cell using solid fuel.

The anode flow field board according to the present invention could have an extremely light overall weight, and low manufacturing cost, and provide the anode fuel and anode product with a fluid field environment for smoothly flowing, which disclose the advantages, effects and improvements in the present invention.

The present invention has been described as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. An anode flow field board for fuel, comprises:
a substrate;
a shunt portion, configured at one side of the substrate, in which the shunt portion is to dig a small area of the substrate as a hollow area;
an inlet channel structure, configured on the substrate, which is connected between the shunt portion and at least one slot body;
the slot bodies, arranged and configured on the substrate, in which the configured position for each slot body is correspondingly associated with the configured position of the anode for each membrane electrode assembly;
an outlet channel structure, configured on the substrate and connected between the slot bodies and the outlet hole; and,
an outlet hole, configured on one side of the substrate and connected to the outlet channel structure, in which the outlet hole is to dig a small area of the substrate as a hollow area.

2. The flow field board according to claim 1, further comprises: at least one current collector sheet, which is made of conductive material, and each current collector sheet is attached and fixed on each slot body.

3. The flow field board according to claim 2, wherein the current collector sheet comprises at least one flange, which are protruded from the slot body.

4. The flow field board according to claim 1, wherein the inlet channel structure is a structure with uniform flow volume.

5. The flow field board according to claim 1, wherein the slot body is formed by a plurality of parallel slots.

6. The flow field board according to claim 1, wherein a portion of the outlet channel structure is a strip-like hollow structure; and, the other portion of the outlet channel structure is a slot structure.

7. The flow field board according to claim 1, wherein the substrate is selected one from anti-chemical non-conductor engineering plastic substrate, graphite substrate, metal substrate, plastic carbon substrate, FR4 substrate, FR5 substrate, epoxy resin substrate, glass-fiber substrate, ceramic substrate, polymer plasticized substrate, and composite material substrate.

8. The flow field board according to claim 1, wherein the substrate is further configured with a printed circuitry, and the printed circuitry is electrically connected to the current collector sheets.

9. The flow field board according to claim 2, wherein the current collector sheet is selected one from stainless steel (SUS316) sheet, gold foil, titanium metal, graphite material, carbon metal compound material, metal alloy sheet, and polymer conductive sheet with low resistance.

10. The flow field board according to claim 1, wherein the flow field board is a single-face flow field board.

11. The flow field board according to claim 1, wherein the flow field board is a dual-face flow field board.

12. The flow field board according to claim 1, wherein the slot body is a recessed structure from the surface of the substrate.

13. The flow field board according to claim 1, wherein the slot body is formed with a plurality of crossed slots.

14. The flow field board according to claim 1, further comprises at least one electric component, which are configured on the substrate.

15. The flow field board according to claim 14, wherein these electric components comprise: a temperature sensor, a density sensor, a liquid level sensor, a heating device, a cooling device, and a heating filament.

16. The flow field board according to claim 1, further comprises at least one electric component, which are accommodated in the inner space of the shunt portion.

17. The flow field board according to claim 16, wherein these electric components comprise: a temperature sensor, a density sensor, a liquid level sensor, a heating device, a cooling device, and a heating filament

18. The flow field board according to claim 1, wherein the shunt portion and the outlet hole are configured at the same side of the substrate.

19. The flow field board according to claim 1, further comprises at least conductive sheet, which are configured and sandwiched between each current collector sheet and each slot body.
